(19) United States
(12) Patent Application Publication
(10) Pub. No.: US 2011/0246704 A1
(43) Pub. Date: Oct. 6, 2011

(54) METHOD FOR OPERATING NON-VOLATILE FLASH MEMORY WITH WRITE PROTECTION MECHANISM

(75) Inventors: Tsung-Pao NIEN, Hsinchu (TW); Ming-Te CHOU, Hsinchu (TW); Jian-Hui XIE, Hsinchu (TW)

(73) Assignee: CHINGIS TECHNOLOGY CORPORATION, Hsinchu (TW)

(21) Appl. No.: 12/752,143

(22) Filed: Apr. 1, 2010

(51) Int. Cl. G06F 12/02

(52) U.S. Cl. 711/103; 711/E12.008

(57) ABSTRACT

A method for operating a non-volatile flash memory with a write protection mechanism is provided. The method comprises the steps as follow. A command is issued. When the command is a safeguard information modification command, only when the safeguard information modification command matches the specific combination of the plurality of modification instructions, a safeguard information is allowed to be modified. When the command is a flash memory data modification command, only when both the status register protection information and the safeguard information indicate that the memory block/sector is not under write-protection, the memory block/sector is allowed to be modified according to the flash memory data modification command.

### BACKGROUND

1. Technical Field

The present disclosure relates to a method for operating a non-volatile flash memory. More particularly, the present disclosure relates to a method for operating a non-volatile flash memory with write protection mechanism.

2. Description of Related Art

Write protection skill of non-volatile memory, serial peripheral interface (SPI), is able to prevent non-volatile memory data from being changed by any illegal or undesired command that is issued by the micro controller unit (MCU) when the MCU does not operate normally.

The existing write-protection mechanism makes use of a protection information with a small number of bits indicating the blocks of the memory under protection. However, the instruction to modify the protection information is quite simple, e.g. 00000001b. Therefore, the non-volatile memory suffers from the data-changed issue generated when the system power of the computer system is not stable or when any un-desired power down occurs. When the power of the system board goes down to a certain level, the MCU of the system may fail to operate properly and may issue a series of undesired command to the SPI interface. If the undesired command happens to match the simple instruction described above, the protected memory array may become writable due to the undesired command. Consequently, it may lead to system reboot fail because the code in the memory is changed during power down.

Accordingly, what is needed is a method for operating a non-volatile flash memory with a proper write protection mechanism to avoid the defect described above. The present disclosure addresses such a need.

### SUMMARY

An aspect of the present disclosure is to provide a method for operating a non-volatile flash memory with a write protection mechanism, wherein the method comprises the steps as follow. A command is issued. Whether the command is a safeguard information modification command or a flash memory data modification command is determined. When the command is a safeguard information modification command, whether the safeguard information modification command matches a specific combination of a plurality of modification instructions is determined. Only when the safeguard information modification command matches the specific combination of the plurality of modification instructions, a safeguard information is allowed to be modified according to the modified safeguard information modification command. When the command is a flash memory data modification command, whether a status register protection information indicates that a memory block/sector of the non-volatile flash memory is under write-protection and whether the safeguard information indicates that the memory block/sector is under write-protection is determined. Only when both the status register protection information and the safeguard information indicate that the memory block/sector is not under write-protection, the memory block/sector is allowed to be modified according to the flash memory data modification command.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is an electronic apparatus system of an embodiment of the present disclosure; and

FIG. 2 is a flow chart of a method for operating a non-volatile flash memory with a write protection mechanism;

FIG. 3 is a diagram depicting the specific combination of the modification instructions in an embodiment of the present disclosure;

FIG. 4 is a diagram depicting the specific combination of the modification instructions in another embodiment of the present disclosure; and

FIG. 5 is another flow chart depicting the erase/program procedure of the non-volatile flash memory.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

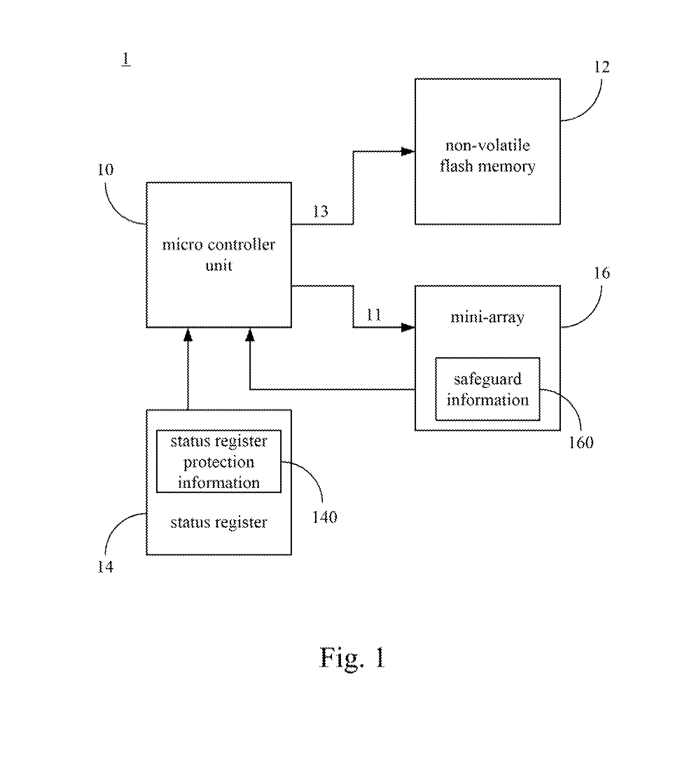

Please refer to FIG. 1. FIG. 1 is an electronic apparatus system 1 of an embodiment of the present disclosure. The electronic apparatus system 1 can be a LCD scalar, a camera module, a mobile phone or PC peripheral in different embodiments. The electronic apparatus system 1 comprises a micro controller unit 10, a non-volatile flash memory 12, a status register 14 and a mini-array 16.

The micro controller unit 10 is able to issue commands to modify the data in the non-volatile flash memory 12, the status register 14 and the mini-array 16 when these modules are allowed to be modified. The non-volatile flash memory 12 in an embodiment comprises a function code area and a parameter-setting area (not shown). The parameter-setting area stores a plurality of parameters that can be modified frequently by user. The function code area stores a plurality of function codes, whereas these function codes are to perform specific functions and are not allowed being modified by the user. For example, in a LCD module, the user can modify the parameters stored in the parameter-setting area such as the brightness, the chroma, and the size of the display frame. On the contrary, the function code area stores the function codes for the operation of the LCD module. If the function codes are modified, the LCD module may fail to operate normally. Therefore, a write-protection mechanism is needed to prevent the function code area of the non-volatile flash memory 12 from being modified.

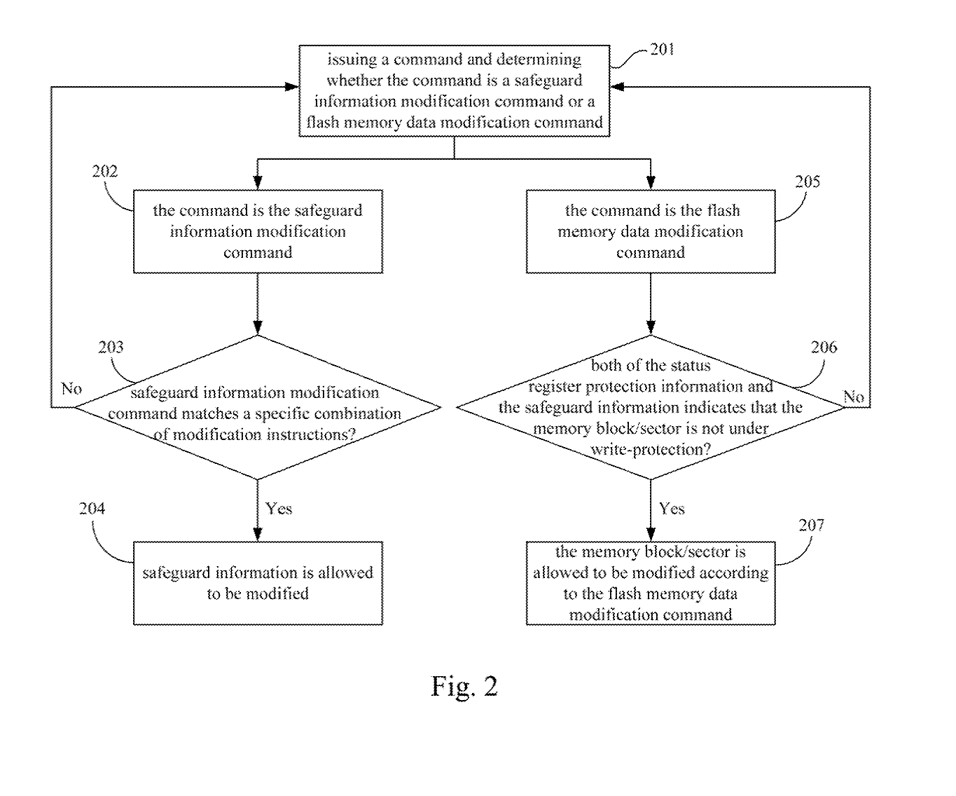

Please refer to FIG. 2 at the same time. FIG. 2 is a flow chart of a method for operating a non-volatile flash memory with a write protection mechanism. The method can be adapted to the electronic apparatus system 1 depicted in FIG. 1. (The steps are not recited in the sequence in which the steps are performed. That is, unless the sequence of the steps is expressly indicated, the sequence of the steps is interchangeable, and all or part of the steps may be simultaneously, partially simultaneously, or sequentially performed.)

The method comprises the steps as follow. In step 201, a command is issued by the micro controller unit 10 and whether the command is a safeguard information modification command or a flash memory data modification command is determined. When the command is a safeguard information modification command 11, step 202 is performed to determine that the command is the safeguard information modification command 11. The safeguard information modification command 11 is to modify the safeguard information 160 stored in the mini array 16.

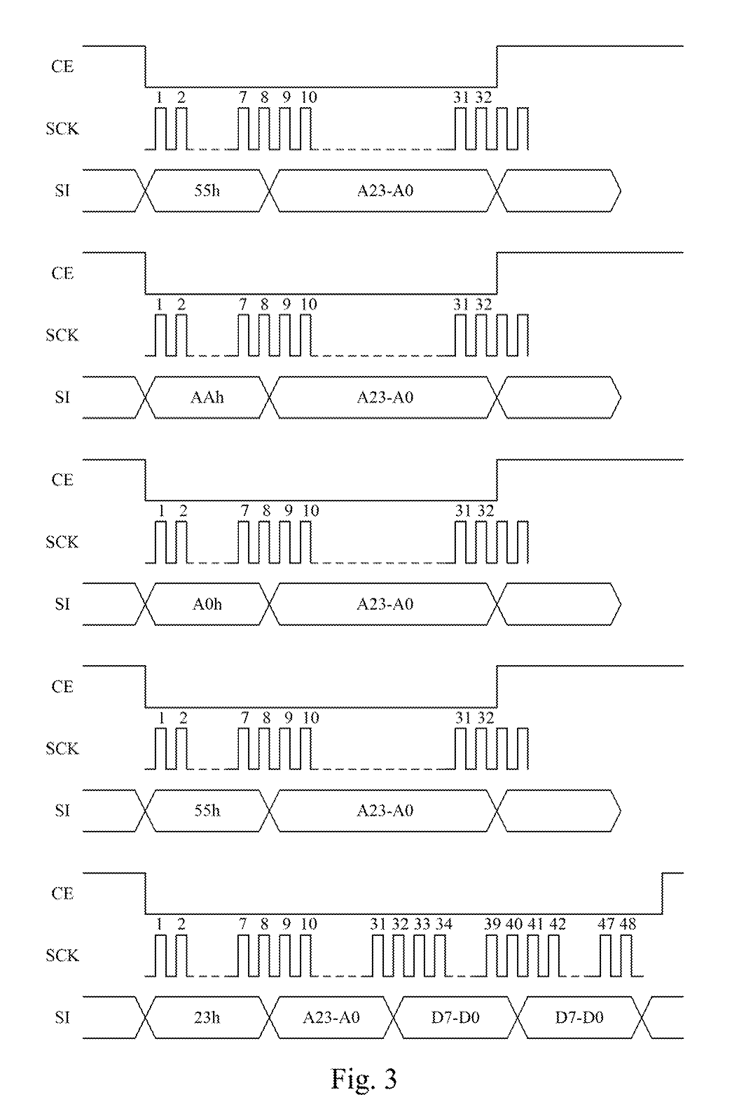

In step 203, whether the safeguard information modification command 11 matches a specific combination of a plurality of modification instructions is determined. In an embodiment, the safeguard information modification command 11 is to program the safeguard information 160 stored in the mini array 16. Please refer to FIG. 3. FIG. 3 is a diagram depicting the specific combination of the modification instructions in an embodiment of the present disclosure. As shown in FIG. 3, CE stands for chip enable signal, SCK stands for the serial data clock signal and SI stands for the serial data input signal. When CE goes high, any operation is not allowed being performed on the chip. In contrast, when CE goes low, the commands sent through the SI can perform modification on the chip.

As depicted in FIG. 3, the specific combination of the modification instructions comprises a plurality of program instructions, an address instruction and at least one setting instruction. The program instructions are 55h, AAh, A0h, 55h and 23h in the present embodiment, whereas the address instruction is depicted as A23-A0. However, during the transmission of the program instructions, the address instructions shown behind the program instructions from the first 55h to the last 55h are substantially an unknown signal and only the address instruction behind the program instruction 23h comprises the actual address. The address indicates the block address of the non-volatile flash memory 12, whereas the setting instruction depicted as D7-D0 in FIG. 3 indicates the sector of the non-volatile flash memory 12 to be programmed. In an embodiment, the setting instruction comprises 8 protection bits each indicating whether a sector of the non-volatile flash memory is under write-protection. For example, 0 sets the sector to be protected, whereas 1 sets the sector to be writable.

Please refer to TABLE 1. TABLE 1 shows an example of the setting instruction.

TABLE 1

| | Address | D7 | D6 | D5 | D4 | D3 | D2 | D1 | DO |
|---|---|---|---|---|---|---|---|---|---|
| Sector 0 | 000h | 1 | 1 | 1 | 1 | 1 | 1 | 1 | 0 |
| Sector 1 | 000h | 1 | 1 | 1 | 1 | 1 | 1 | 0 | 1 |
| Sector 2 | 000h | 1 | 1 | 1 | 1 | 1 | 0 | 1 | 1 |
| Sector 3 | 000h | 1 | 1 | 1 | 1 | 0 | 1 | 1 | 1 |
| Sector 4 | 000h | 1 | 1 | 1 | 0 | 1 | 1 | 1 | 1 |
| Sector 5 | 000h | 1 | 1 | 0 | 1 | 1 | 1 | 1 | 1 |
| Sector 6 | 000h | 1 | 0 | 1 | 1 | 1 | 1 | 1 | 1 |
| Sector 7 | 000h | 0 | 1 | 1 | 1 | 1 | 1 | 1 | 1 |
| Sector 8 | 001h | 1 | 1 | 1 | 1 | 1 | 1 | 1 | 0 |
| Sector 9 | 001h | 1 | 1 | 1 | 1 | 1 | 1 | 0 | 1 |
| . | . | . | . | . | . | . | . | . | . |
| . | . | . | . | . | . | . | . | . | . |
| . | . | . | . | . | . | . | . | . | . |
| Sector(8X) | 00Xh | 1 | 1 | 1 | 1 | 1 | 1 | 1 | 0 |
| Sector(8X + 1) | 00Xh | 1 | 1 | 1 | 1 | 1 | 1 | 0 | 1 |
| Sector(8X + 2) | 00Xh | 1 | 1 | 1 | 1 | 1 | 0 | 1 | 1 |
| . | . | . | . | . | . | . | . | . | . |
| . | . | . | . | . | . | . | . | . | . |
| . | . | . | . | . | . | . | . | . | . |

As shown in TABLE 1, the address indicates the block of the non-volatile flash memory 12, and each bit of the setting instruction D7-D0 corresponds to a sector of the block. If the address instruction is 001h and the setting instruction is 11101111, for example, the fifth sector of the block with the address 001h is under write-protection. In an embodiment, if two setting instructions are issued as depicted in FIG. 3, the block address of the later one equals to the block address of the former one plus one. In other words, if the address of the setting instructions is 001h, then the later setting instruction indicates the sector of the to block with the address 002h.

It's noticed that the above arrangement can be different in other embodiments. For example, the number of the program instructions or the order of these instructions can be easily modified by those skilled in the art. Also, the safeguard information 160 can be stored in other kinds of storage modules.

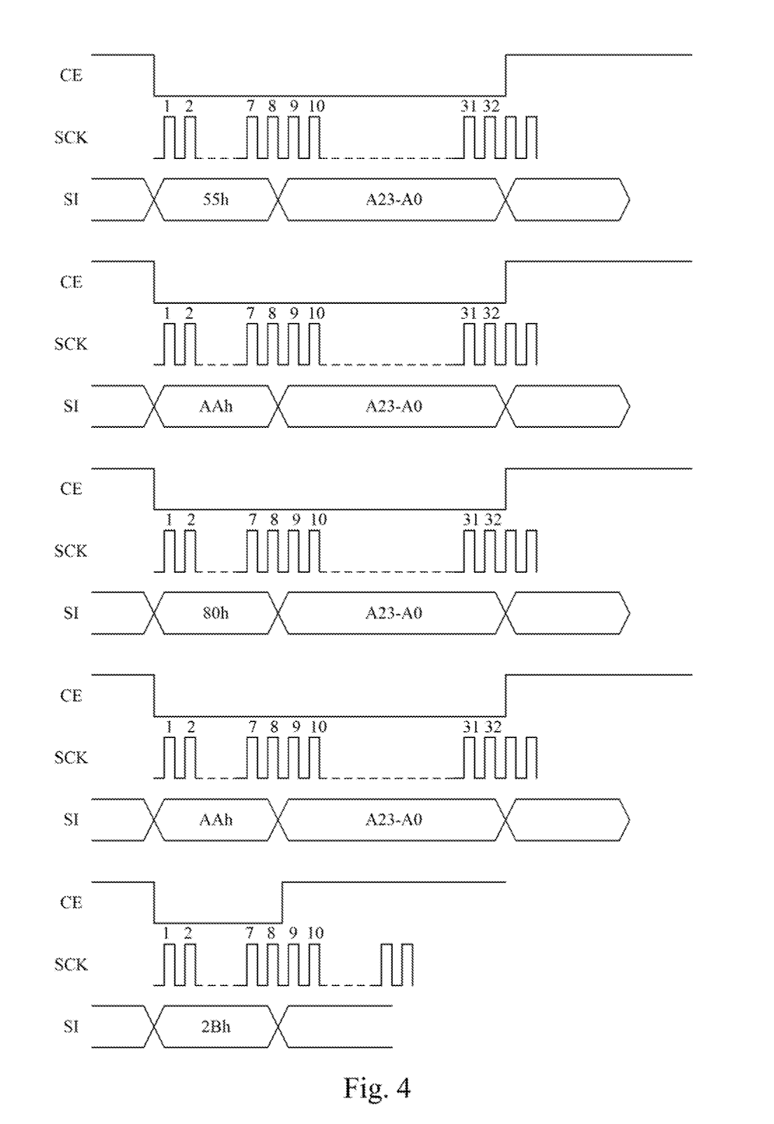

In another embodiment, the safeguard information modification command 11 is to erase the safeguard information stored in the mini array 160. Under such circumstance, the specific combination of the modification instructions comprises a plurality of erase instructions, as depicted in FIG. 4. The erase instructions can be a series of instructions comprising, for example, 55h, AAh, 80h, AAh and 2Bh and can be sent through SI like the program instructions in the previous embodiment. However, no address instruction is needed during the erase process since the erase instructions are to erase all the data in the safeguard information.

Please refer to FIG. 1 and FIG. 2 again. As a result, only when the safeguard information modification command 11 matches the specific combination of the plurality of modification instructions, the step 204 can be performed such that the safeguard information 160 is allowed to be modified, whether program or erase, according to the modified safeguard information modification command 11. Thus, complex modification procedure prevents the safeguard information 160 from being changed by undesired commands generated by unstable system power or undesired power down.

On the other hand, when the command is a flash memory data modification command 13, step 205 is performed to determine that the command is the flash memory data modification command 13. Then in step 206, whether a status register protection information 140 indicates that a memory block/sector of the non-volatile flash memory 12 is under write-protection and whether the safeguard information indicates that the memory block/sector is under write-protection is determined.

The status register protection information 140 is stored in the status register 14. In an embodiment, the status register protection information 140 comprises 3 protection bits each indicates whether a range of the blocks of the non-volatile flash memory 12 is under write-protection. For example, the code 011 may represent that the block 4-7 of the non-volatile flash memory 12 is under write-protection, whereas the code 000 represents none of the block is under write-protection. However, the command to modify the status register protection information 140 is easier compared to the safeguard information 160. If only the status register protection information 140 is used, the undesired command may change the content of the status register protection information 140 such that the electronic apparatus system 1 may not operate normally.

Thus, in step 206, only when both the status register protection information 140 and the safeguard information 160 indicate that the memory block/sector is not under write-protection, the memory block/sector is allowed to be modified, whether erase or program, according to the flash memory data modification command 13.

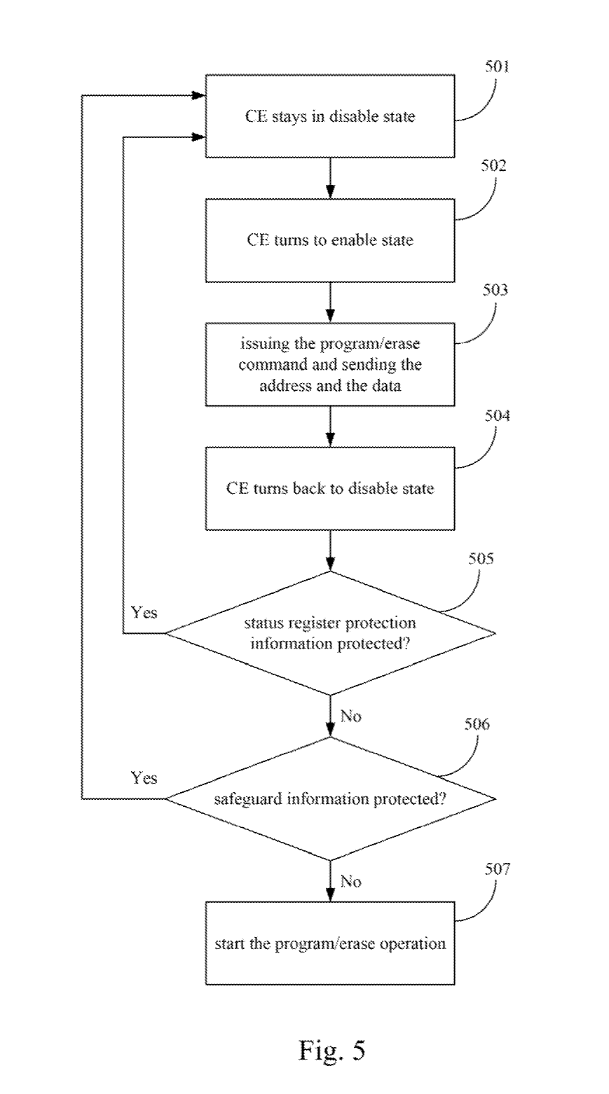

Substantially, during the erase/program procedure of the non-volatile flash memory 12, the CE has to turn from disable state (standby mode) to enable state as well. Please refer to FIG. 5. FIG. 5 is another flow chart depicting the erase/program procedure of the non-volatile flash memory 12. (The steps are not recited in the sequence in which the steps are performed. That is, unless the sequence of the steps is expressly indicated, the sequence of the steps is interchangeable, and all or part of the steps may be simultaneously, partially simultaneously, or sequentially performed.)

In step 501, CE stays in disable state, which is a high state in an embodiment. In step 502, CE turns to enable state, which is a low state contrary to the high state. In step 503, the program/erase command is issued, and the address and the data are sent. Then in step 504, CE turns back to disable state. In step 505, whether the status register protection information 140 indicates that the block to be modified is under protection is determined. When the status register protection information 140 indicates that the block to be modified is under protection, the program/erase command fail to modify the block of the non-volatile flash memory 12. When the status register protection information 140 indicates that the block to be modified is not under protection, step 506 is performed to determine whether the safeguard information 160 indicates the block to be modified is under protection. When the safeguard information 160 indicates that the block to be modified is under protection, the program/erase command fails to modify the block of the non-volatile flash memory 12. When the safeguard information 160 indicates that the block to be modified is not under protection, step 507 is performed to start the program/erase operation.

Through the write-protection mechanism provided by the status register protection information 140 and the more robust safeguard information 160, the function codes of the non-volatile flash memory 12 is not easy to be modified by undesired commands.

It will be apparent to those skilled in the art that various modifications and variations can be made to the structure of the present disclosure without departing from the scope or spirit of the invention. In view of the foregoing, it is intended that the present disclosure cover modifications and variations of this invention provided they fall within the scope of the following claims.

What is claimed is:

1. A method for operating a non-volatile flash memory with a write protection mechanism, wherein the method comprises the steps of:
issuing a command;
determining whether the command is a safeguard information modification command or a flash memory data modification command;
when the command is a safeguard information modification command, determining whether the safeguard information modification command matches a specific combination of a plurality of modification instructions, wherein only when the safeguard information modification command matches the specific combination of the plurality of modification instructions, a safeguard information is allowed to be modified according to the modified safeguard information modification command;
when the command is a flash memory data modification command, determining whether a status register protection information indicates that a memory block/sector of the non-volatile flash memory is under write-protection and whether the safeguard information indicates that the memory block/sector is under write-protection, wherein only when both the status register protection information and the safeguard information indicate that the memory block/sector is not under write-protection, the memory block/sector is allowed to be modified according to the flash memory data modification command.

2. The method of claim 1, wherein the safeguard information is stored in a mini-array.

3. The method of claim 1, wherein the specific combination of modification instructions comprise a plurality of program instructions, an address instruction and at least one setting instruction.

4. The method of claim 2, wherein the address instruction is corresponding to a block of the non-volatile flash memory and the setting instruction comprises a plurality of protection bits each indicating whether a sector of the non-volatile flash memory is under write-protection.

5. The method of claim 1, wherein the specific combination of modification instructions comprise a plurality of erase instructions.

6. The method of claim 1, wherein the flash memory data modification command is a flash memory program command.

7. The method of claim 1, wherein the flash memory data modification command is a flash memory erase command.

8. The method of claim 1, wherein the non-volatile flash memory comprises a function code area and a parameter-setting area, wherein the flash memory data modification command modifies the data in the function code area.

9. The method of claim 1, wherein the status register protection information is a 3-bit information indicating the blocks of the non-volatile flash memory under write-protection.

10. The method of claim 1, wherein a chip enable signal turns from a disable state to an enable state before the command is issued.

11. The method of claim 1, wherein the command is issued by a micro controller unit.
